(19) United States
(12) Patent Application Publication
(10) Pub. No.: US 2014/0359031 A1
(43) Pub. Date: Dec. 4, 2014

(54) MESSAGE CONTROL METHOD AND MESSAGE CONTROL SYSTEM

(71) Applicant: FUJITSU LIMITED, Kawasaki-shi (JP)

(72) Inventor: Atsushi MARUYAMA, Kawasaki (JP)

(73) Assignee: FUJITSU LIMITED, Kawasaki-shi (JP)

(21) Appl. No.: 14/255,193

(22) Filed: Apr. 17, 2014

(30) Foreign Application Priority Data
May 31, 2013 (JP) 2013-116455

(51) Int. Cl. H04L 12/58

(52) U.S. Cl. CPC H04L 51/34; H04L 51/24
USPC 709/206

(57) ABSTRACT

Based on information extracted from a message created and addressed to a group, a setting unit sets a responsible person of the message from a plurality of members corresponding to the group. An adding unit adds the message to message lists of the plurality of members. According to confirmation of the message by the responsible person, a removing unit removes the message from the message lists of the plurality of members except the responsible person.

### CROSS-REFERENCE TO RELATED APPLICATIONS

This application is based upon and claims the benefit of priority of the prior Japanese Patent Application No. 2013-116455, filed on May 31, 2013, the entire contents of which are incorporated herein by reference.

### FIELD

The embodiments discussed herein are related to a message control method and a message control system.

### BACKGROUND

Heretofore, a plurality of responsible persons sometimes provides services to a user. For example, in home care, doctors, nurses, caregivers, and pharmacists, for example, provide medical care, nursing, and nursing care to a patient from their standpoints. Information about the conditions of a patient, for example, is shared between responsible persons who are in charge of the patient. For example, in the case where a caregiver makes contact with a doctor, for example, about changes in the conditions of a patient of whom the caregiver takes care on telephone calls, electronic mail messages, and facsimiles, for example.

However, in the case where when responsible persons belong to different organizations, it takes time and effort to make contact with each other. For example, generally, a doctor and a caregiver belong to different organizations as the doctor belongs to a clinic and the caregiver belongs to a nursing care station. Therefore, in the case where a caregiver makes contact with a doctor, the caregiver makes contact with a clinic, for example, which is a different organization, the caregiver inquires about a contact address of the doctor who is in charge of the same patient, and makes contact with the contact address.

Therefore, there is a previously existing technique for sharing information between a plurality of responsible persons, in which a representative address is generated, for example, email messages addressed to the representative address are sorted to responsible persons, and the responsible persons can make reference to the email messages. FIG. 30 is a diagram of an incoming mail display screen according to a previously existing technique. In this previously existing technique, email messages addressed to individual persons and email messages addressed to a representative address are stored and stored in different folders. The incoming mail display screen is provided with account select buttons of “personal”, “Section B”, and “Section C”. “Personal” is a button that displays email messages addressed to the individual persons. “Section B” and “Section C” are buttons that display email messages addressed to the representative addresses of the sections. The example in FIG. 30 illustrates the state in which email messages addressed to the representative address of Section B is displayed in a list. The opened message number expresses how many responsible persons read a message in responsible persons to whom email messages are sorted. The status expresses the state of a reply to a mail message. The status is displayed, in which in the case where any one of responsible persons to which a mail message is sorted gives a reply, “Replied” is displayed, in the case where any one of the responsible persons is making a reply, “Being Made” is displayed, and in the case where no one of the responsible persons gives a reply, “Not Replied” is displayed.

Patent Literature 1: Japanese Laid-open Patent Publication No. 2009-175900

However, in the case where contact is made to a responsible person at a different organization by telephone calls, electronic mail messages, and facsimiles, for example, it is need to check a contact address of the responsible person. Moreover, in the case where a responsible person is on leave, for example, it is not enabled to do follow-up a patient.

Furthermore, for example, in the case where contact is made to a different organization for a responsible person at the different organization using the previously existing technique, it is not enabled to do follow-up a patient in the organizations when the responsible person is on leave, for example, and a message is also forwarded to staff members other than the responsible person. However, in the previously existing technique, in the case where a message is forwarded to staff members other than a responsible person as well, the forwarded message is left in the inbox lists of the staff members even though the responsible person confirms the message.

### SUMMARY

According to an aspect of an embodiment, a message control method includes setting, based on information extracted from a message created and addressed to a group, a responsible person of the message from a plurality of members associated with the group; adding the message to message lists of the plurality of members; and according to confirmation of the message by the responsible person, removing the message from the message lists of the plurality of members except the responsible person.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram of an exemplary configuration of an organization according to the embodiment;

FIG. 2 is a diagram of an exemplary configuration of a simplified organization according to the embodiment;

FIG. 3 is a diagram of exemplary configurations of databases;

FIG. 4 is a schematic diagram of an exemplary configuration of a message control system;

FIG. 5 is a diagram of an exemplary data configuration of a shared patient information table;

FIG. 6 is a diagram of an exemplary data configuration of an associated establishment information table;

FIG. 7 is a diagram of an exemplary data configuration of a message control table;

FIG. 8 is a diagram of an exemplary data configuration of a message reader table;

FIG. 9 is a diagram of an exemplary data configuration of a patient information table of Establishment F;

FIG. 10 is a diagram of an exemplary data configuration of a staff member information table of Establishment F;

FIG. 11 is a diagram of an exemplary data configuration of an establishment information table of Establishment F;

FIG. 12 is a diagram of an exemplary data configuration of a personal message control table of Establishment F;

FIG. 13 is a diagram of an exemplary data configuration of a patient information table of Establishment G;

FIG. 14 is a diagram of an exemplary data configuration of a staff member information table of Establishment G;

FIG. 15 is a diagram of an exemplary data configuration of an establishment information table of Establishment G;

FIG. 16 is a diagram of an exemplary data configuration of a personal message control table of Establishment G;

FIG. 17 is a diagram of an exemplary display screen when sending a message;

FIG. 18 is a diagram of an exemplary change in data due to sending the message illustrated in FIG. 17;

FIG. 19 is a diagram of an exemplary display screen when a staff member other than a responsible person confirms a message;

FIG. 20 is a diagram of an exemplary change in data due to confirming the message illustrated in FIG. 19;

FIG. 21 is a diagram of an exemplary display screen when a responsible person confirms a message;

FIG. 22 is a diagram of an exemplary change in data due to confirming the message illustrated in FIG. 21;

FIG. 23 is a flowchart of exemplary procedures of a message transmission process;

FIG. 24 is a flowchart of exemplary procedures of a message distribution process;

FIG. 25 is a flowchart of exemplary procedures of an unread message list display process;

FIG. 26 is a flowchart of exemplary procedures of a flag update process;

FIG. 27 is a flowchart of exemplary procedures of an outgoing message list display process;

FIG. 28 is a flowchart of exemplary procedures of a reader list display process;

FIG. 29 is a diagram of a computer that executes a message control program; and

FIG. 30 is a diagram of an incoming mail display screen according to a previously existing technique.

### DESCRIPTION OF EMBODIMENTS

Preferred embodiments of the present invention will be explained with reference to accompanying drawings. It is noted that the present invention is no limited to the embodiments. The embodiments can be appropriately combined in the scope consistent to the description of processes.

### [a] First Embodiment

### The Configurations of Organizations

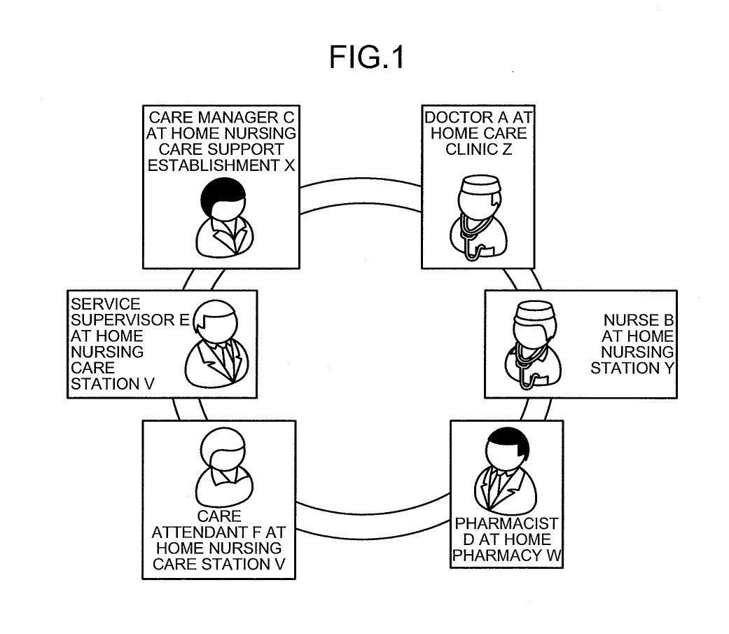

First, an exemplary configuration of an organization according to a first embodiment will be described. FIG. 1 is a diagram of an exemplary configuration of an organization according to the embodiment. Heretofore, a plurality of responsible persons sometimes provides services to a user in cooperation with each other. For example, in home care, doctors, nurses, caregivers, and pharmacists provide services such as medical care, nursing, and nursing care to a patient from their standpoints. In this case, responsible persons sometimes belong to different organizations. For example, in the example in FIG. 1, Doctor A belongs to Home care clinic Z. Nurse B belongs to Home nursing station Y. Care manager C belongs to Home nursing care support establishment X. Pharmacist D belongs to Home pharmacy W. Service supervisor E belongs to Home nursing care station V. Care attendant F belongs to Home nursing care station V. In the case where a plurality of responsible persons provides services to a user in cooperation with each other as described above, information is sometimes shared between the responsible persons. For example, in home care, information about the conditions of a patient, for example, is shared between Doctor A, Nurse B, Care manager C, Pharmacist D, Service supervisor E, and Care attendant F. In the embodiment, the case will be described where information is shared between responsible persons using a message control system.

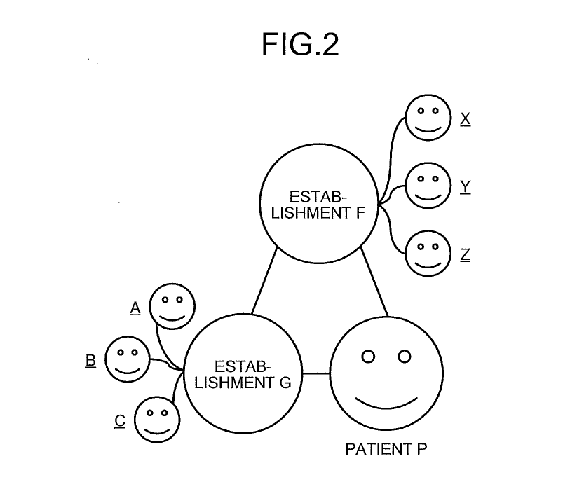

It is noted that in the following, for simplifying the description, the case is taken as an example in which responsible persons belonging to two establishments provide services to Patient P. FIG. 2 is a diagram of an exemplary configuration of a simplified organization according to the embodiment. As illustrated in FIG. 2, Staff members X, Y, and Z belong to Establishment F. Staff members A, B, and C belong to Establishment G. Patient P receives services from Establishment F and Establishment G. Suppose that a responsible person for Patient P is Staff member X at Establishment F. Suppose that a responsible person for Patient P is Staff member A at Establishment G.

The Configurations of Databases

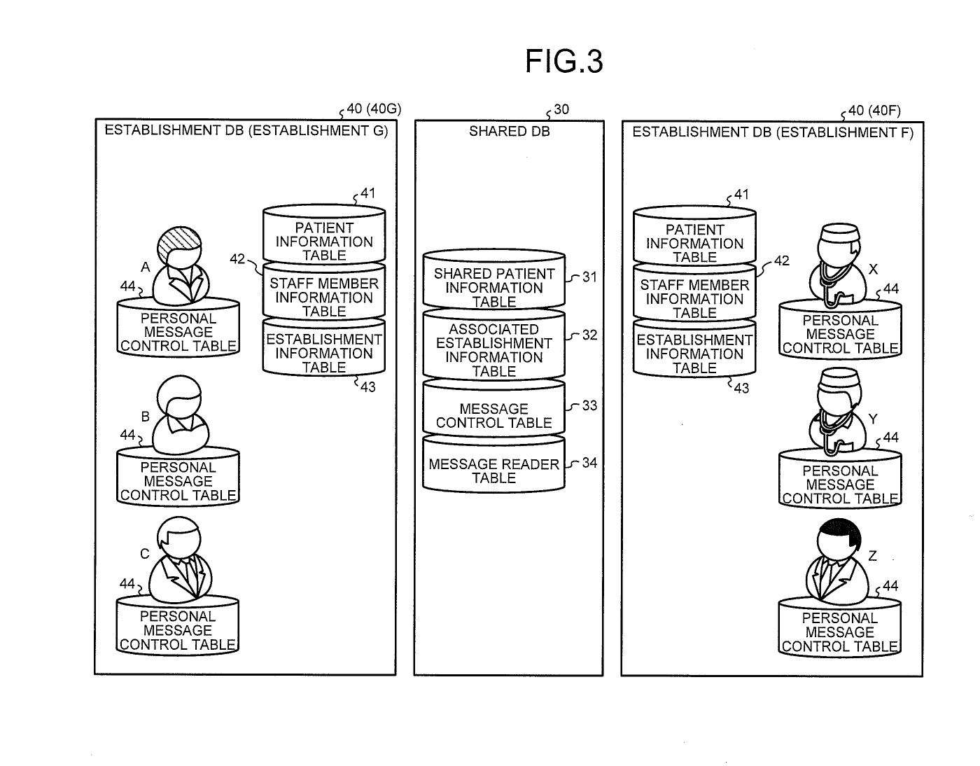

Next, the configurations of databases (DBs) for use in the message control system according to the embodiment will be described. FIG. 3 is a diagram of exemplary configurations of databases. In the message control system according to the embodiment, databases are controlled as a shared DB 30 and an establishment DB 40. In the example in FIG. 3, two establishments DB 40 are provided for Establishment F and Establishment G.

The shared DB 30 is a database that controls information about the establishments and controls information controlled by sharing. The shared DB 30 includes a shared patient information table 31, an associated establishment information table 32, a message control table 33, and a message reader table 34. The detailed configurations of the tables will be described later.

The establishment DB 40 is a database that is individually provided for the establishments and controls information about the individual establishments. The establishment DB 40 includes a patient information table 41, a staff member information table 42, an establishment information table 43, and a plurality of personal message control tables 44. The detailed configurations of the tables will be described later as well.

The Configuration of the Message Control System

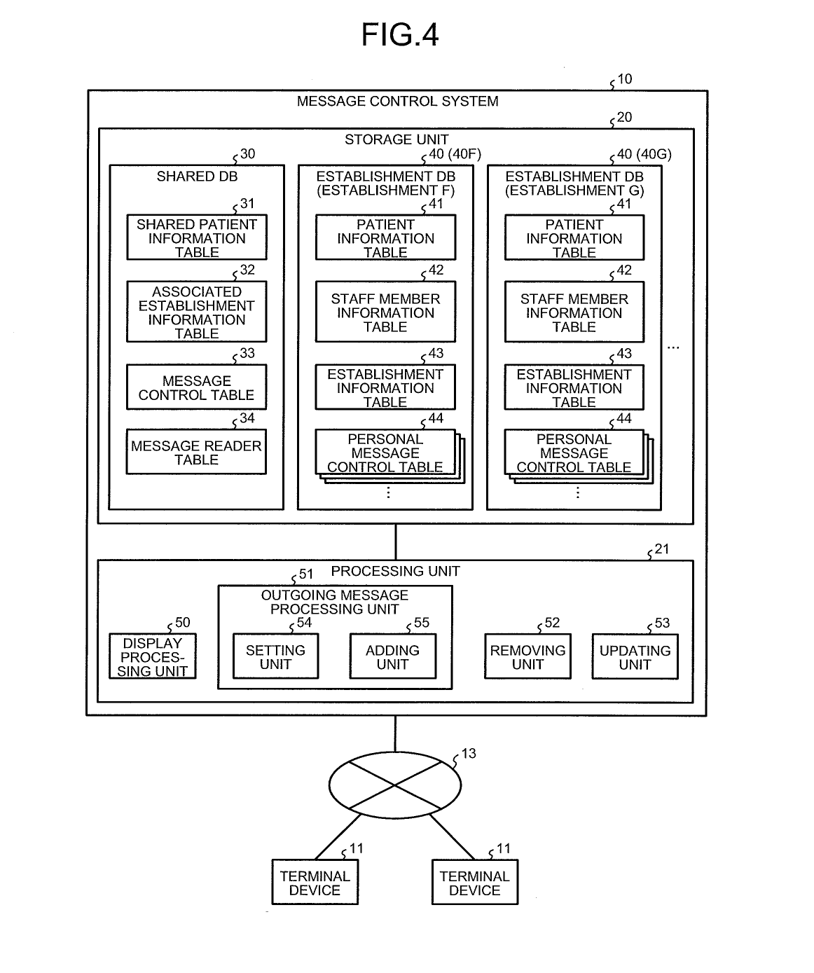

Next, the functional configuration of a message control system 10 according to the embodiment will be described. FIG. 4 is a schematic diagram of an exemplary configuration of a message control system. The message control system 10 is connected to a terminal device 11 which can communicate with each other via a network 13 and can exchange various items of information with each other. As a form of the network 13, a given communication network is named including a LAN (Local Area Network), a VPN (Virtual Private Network), and a mobile telecommunication network regardless of cable communication networks or wireless communication networks.

The terminal device 11 is a device that can be used by a staff member of an establishment for making contact with other staff members using electronic mail messages. For example, the terminal device 11 may be a tablet terminal, a smartphone, and a PDA (Personal Digital Assistant). Moreover, the terminal device 11 may be an information processing apparatus such as a desktop PC (Personal Computer) and a notebook PC. It is noted that in the example in FIG. 4, the case is illustrated where two terminal devices 11 are included. However, the disclosed system is not limited thereto, and a given number of the terminal devices 11 can be provided.

The message control system 10 is a system that operates on a server computer provided on a center, for example, and sorts and controls messages such as electronic mail messages created and addressed to staff members at the establishment using the terminal devices 11. The message control system 10 may operate on a single computer or may distributedly operate on a plurality of computers such as a cloud computing network. Moreover, the message control system 10 may operate on one or plurality of VMs (Virtual Machines) operating on a computer.

As illustrated in FIG. 4, the message control system 10 includes a storage unit 20 and a processing unit 21. It is noted that the message control system 10 may include various function units other than the function units illustrated in FIG. 4.

The storage unit 20 is a function unit that stores various items of data. For example, the storage unit 20 is a storage device such as a hard disk, and a SSD (Solid State Drive) installed on a disk array device and a server computer and a semiconductor memory such as a RAM (Random Access Memory) and a flash memory. It is noted that various items of data may be distributed on a plurality of devices.

The storage unit 20 stores various items of data for use in the processing unit 21. For example, the storage unit 20 stores the shared DB 30 and a plurality of the establishments DB 40. In the example in FIG. 4, two establishments DB 40 are provided for Establishment F and Establishment G. In the following, in the establishment DB 40, in the case where the establishment DB 40 for Establishment F is described, it is denoted as an establishment DB 40F, and in the case where the establishment DB 40 for Establishment G is described, it is denoted as an establishment DB 40G.

The shared DB 30 includes a shared patient information table 31, an associated establishment information table 32, a message control table 33, and a message reader table 34. Moreover, the establishment DB 40 includes a patient information table 41, a staff member information table 42, an establishment information table 43, and a plurality of personal message control tables 44.

Next, the data configurations of the tables will be described. First, the data configurations of the tables included in the shared DB 30 will be described. The shared patient information table 31 is a table that stores information about a patient as a user to which services are provided. For example, the shared patient information table 31 stores personal information about the patient and information about the establishment which provides services to the patient.

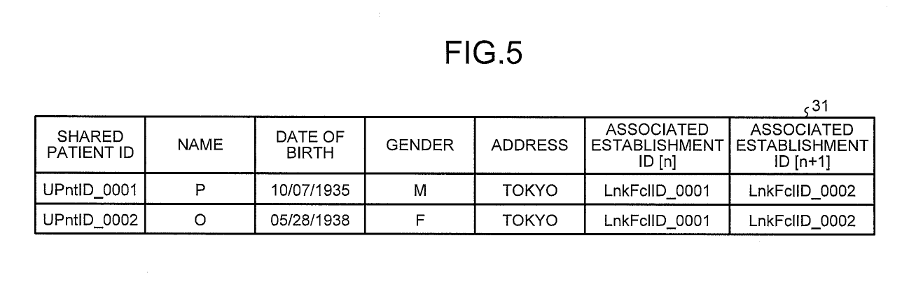

FIG. 5 is a diagram of an exemplary data configuration of the shared patient information table. As illustrated in FIG. 5, the shared patient information table 31 includes entries of a “shared patient ID”, a “name”, a “date of birth”, “gender”, an “address”, and an “associated establishment ID”.

The entry of the shared patient ID is a region that stores identification information used in common between the establishments to identify a patient. The patients are individually given a shared patient ID as identification information to identify the patients by combining numerical characters and characters, for example. The entry of the shared patient ID stores a shared patient ID given to a patient. The entry of a name, a date of birth, gender, and an address are regions that store a name, a date of birth, gender, and an address as personal information about the patient. In the entry of the gender, “M” expresses male and “F” expresses female. The entry of the associated establishment ID is a region that stores identification information about the establishment that provides services to the patient. The establishments are individually given an associated establishment ID as identification information to identify the establishments. A plurality of the entries of the associated establishment IDs is provided. In the example in FIG. 5, a plurality of the entries of the associated establishment IDs is provided as an associated establishment ID[n] and an associated establishment ID[n+1]. The entries of the associated establishment IDs individually store the associated establishment ID of the establishment that provides services to the patient. The example illustrated in FIG. 5 illustrates a patient of shared patient ID “UPntID_{—}0001” as the patient name is “P”, the patient date of birth is on “1935/10/7”, the patient gender is male, and the patient address is “Tokyo”. Moreover, the example illustrated in FIG. 5 illustrates the patient of shared patient ID “UPntID_{—}0001” who receives services from establishments whose associated establishment IDs are “LnkFclID_{—}0001” and “LnkFclID_{—}0002”.

Again referring to FIG. 4, the associated establishment information table 32 is a table that stores information about establishments between which messages can be linked by the message control system 10. For example, the associated establishment information table 32 stores information about establishments between which information about a patient is shared by the message control system 10.

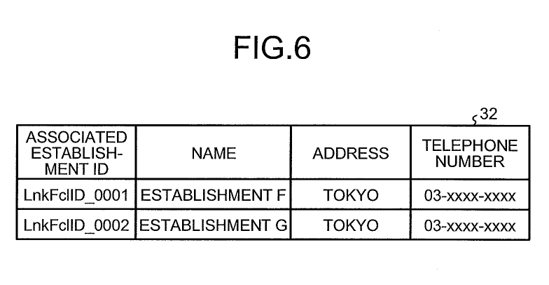

FIG. 6 is a diagram of an exemplary data configuration of the associated establishment information table. As illustrated in FIG. 6, the associated establishment information table 32 includes entries of an “associated establishment ID”, “name”, “address”, and “telephone number”.

The entry of the associated establishment ID is a region that stores the associated establishment IDs to identify the establishments. The entries of the name, address, and telephone number are regions that store the establishment name, the location of the establishment, and the telephone number of the establishment. The example illustrated in FIG. 6 illustrates the establishment of associated establishment ID “LnkFclID_{—}0001” that the name is “Establishment F”, the location is in “Tokyo”, and the telephone number is “03-xxxx-xxxx”.

Again referring to FIG. 4, the message control table 33 is a table that stores information about messages sent addressed to a staff member at the establishment using the message control system 10. For example, the message control table 33 stores information about sent messages.

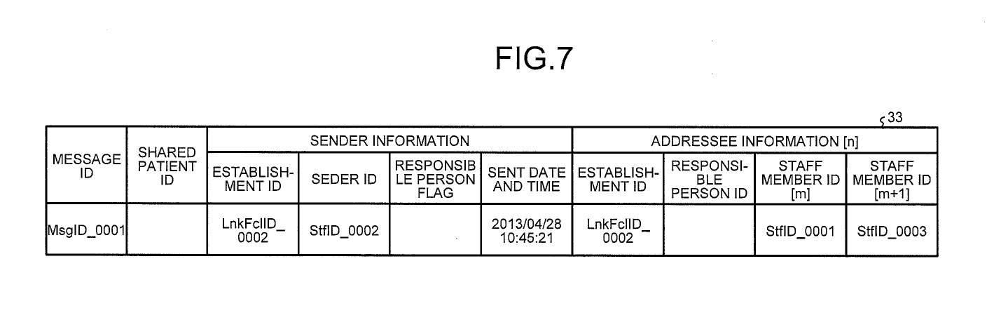

FIG. 7 is a diagram of an exemplary data configuration of the message control table. As illustrated in FIG. 7, the message control table 33 includes entries of a “message ID”, a “shared patient ID”, “sender information”, and “addressee information”.

The entry of the message ID is a region that stores identification information to identify a message. The messages are individually given a message ID as identification information to identify the messages when sending a message is processed. The entry of the message ID stores a message ID given to a message. The entry of the shared patient ID is a region that stores the shared patient ID of a patient. The entry of the shared patient ID stores a shared patient ID in the case where the message is information about the patient shared between responsible persons, whereas the shared patient ID is not stored as blank in the case where the massage is information addressed to a staff member.

The entry of the sender information is a region that stores information about a message sender, and includes entries of an “establishment ID”, “sender ID”, “responsible person Flag”, and “sent date and time”. The entry of the establishment ID of sender information is a region that stores the shared establishment ID of the establishment of a message sender. The entry of the sender ID of sender information is a region that stores identification information of a staff member who is a message sender. The staff members at the establishments are individually given a staff member ID as identification information to identify the staff members. The entry of the sender ID of sender information stores the staff member ID of the staff member who is a message sender. The entry of the responsible person Flag of sender information is a region that stores the determination whether a sender staff member is a responsible person. The entry of the responsible person Flag of sender information stores the determination whether a sender staff member is a responsible person in the case where the message is information about the patient shared between responsible persons. For example, the entry of the responsible person Flag of sender information stores “True” in the case where the sender staff member is a responsible person, whereas the entry of the responsible person Flag of sender information stores “False” in the case where the sender staff member is not a responsible person. The entry of the sent date and time of sender information is a region that stores a date and time when the message is sent.

The entry of addressee information is a region that stores information about the addressee of a message. In order to enable a plurality of the establishments to share information, a plurality of entries of addressee information is provided. In the example in FIG. 7, a plurality of entries of addressee information is provided as addressee information [n]. The entry of addressee information includes entries of an “establishment ID”, “responsible person ID”, and “staff member ID”. The entry of the establishment ID of addressee information is a region that stores the shared establishment ID of an establishment which is a message addressee. The entry of the responsible person of addressee information is a region that stores the staff member ID of the responsible person at the establishment which is a message addressee. The entry of the staff member ID of addressee information is a region that stores information about the addressee of the message. A plurality of the entries of the staff member IDs of addressee information is provided in order to enable sharing information between a plurality of staff members at the establishment. In the example in FIG. 7, a plurality of the entries of the staff member IDs of addressee information is provided as a staff member ID[m] and a staff member ID[m+1]. The entries of the staff member IDs of addressee information individually store the staff member ID of the staff member who is a message addressee. In the example in FIG. 7, the message of message ID “MsgID_{—}0001” expresses a message addressed to an individual person because the shared patient ID is blank. Moreover, the message of message ID “MsgID_{—}0001” expresses that the establishment ID of a sender is “LnkFclID_{—}0002”, the sender is “StfID_{—}0002”, the responsible person Flag is not set, and the sent date and time is “on 2013/04/28 at 10:45:21”. Furthermore, the message of message ID “MsgID_{—}0001” expresses that the establishment ID of an addressee is “LnkFclID_{—}0002” and addressee staff member IDs are “StfID_{—}0001” and “StfID_{—}0003”.

Again referring to FIG. 4, the message reader table 34 is a table that stores information about a staff member who confirms a message.

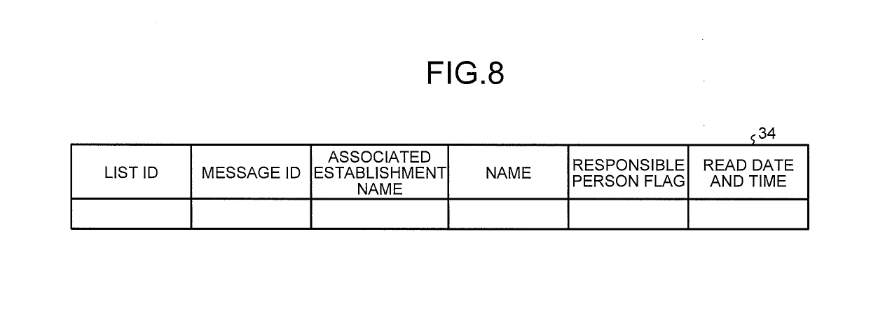

FIG. 8 is a diagram of an exemplary data configuration of the message reader table. As illustrated in FIG. 8, the message reader table 34 includes entries of a “list ID”, “message ID”, “associated establishment name”, “name”, “responsible person Flag”, and “read date and time”.

The entry of the list ID is a region that stores a list ID as identification information to identify a record. The entry of the list ID stores a defined list ID. The entry of the message ID is a region that stores the message ID of a read message. The entry of the associated establishment name is a region that stores the associated establishment ID of the establishment to which a staff member confirming the message belongs. The entry of the name is a region that stores the name of the staff member who confirms the message. The entry of the responsible person Flag is a region that stores the determination whether the staff member who confirms the message is a responsible person. For example, the entry of the responsible person Flag stores “True” in the case where the staff member who confirms the message is a responsible person, whereas the flag stores “False” in the case where the staff member who confirms the message is not a responsible person. The entry of the read date and time is a region that stores a date and time when the massage is read.

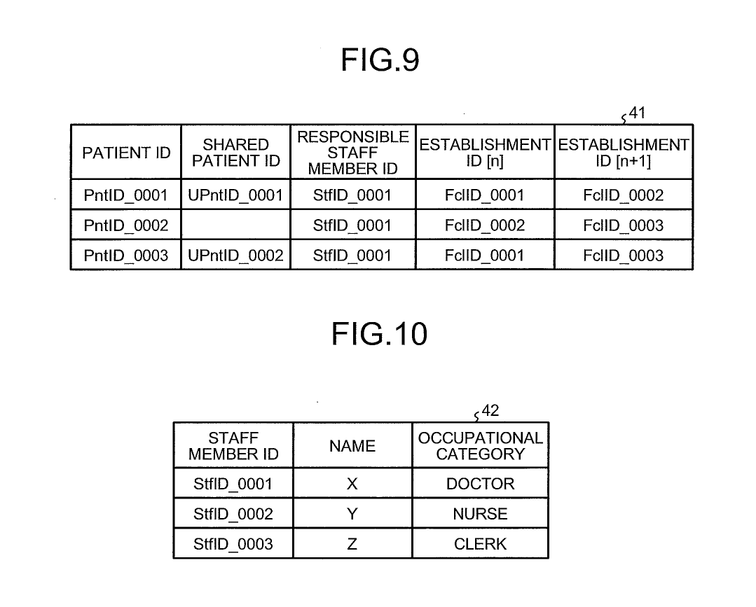

Next, the data configurations of the tables included in the establishment DB 40 will be described. It is noted that the establishment DB 40F and the establishment DB 40G illustrated in FIG. 4 have the same data configuration. In the following, the data configuration will be described as the establishment DB 40F is taken as an example with reference to FIGS. 9 to 12. Stored exemplary items of data will be individually described on the establishment DB 40F and the establishment DB 40G.

The patient information table 41 is a table that stores information about a patient to whom the establishment provides services.

FIG. 9 is a diagram of an exemplary data configuration of the patient information table of Establishment F. As illustrated in FIG. 9, the patient information table 41 includes entries of a “patient ID”, “shared patient ID”, “Responsible staff member ID”, and “establishment ID”.

The entry of the patient ID is a region that stores identification information about a patient at the establishment. In the message control system 10 according to the embodiment, the establishments are enabled to give an original patient ID as identification information to a patient. The entry of the patient ID stores the patient ID of a patient at the establishment. It is noted that the shared patient ID may be used for the patient ID of a patient at the establishment. The entry of the shared patient ID is a region that stores a shared patient ID used in common between the establishments. In the case where a message is shared by the message control system 10, the entry of the shared patient ID stores a shared patient ID. The entry of the responsible staff member ID is a region that stores the staff member ID of a staff member who is in charge of the patient. The entry of the establishment ID is a region that stores the establishment ID of another establishment. A plurality of the entries of the establishment IDs is provided in order to store the establishments that share information. In the example in FIG. 9, a plurality of the entries of the establishment IDs is provided as an establishment ID[n] and an establishment ID[n+1]. The entries of the establishment IDs individually store the establishment IDs of the establishments that share information about the patient. In the example in FIG. 9, the patient of patient ID “PntID_{—}0001” expresses that the shared patient ID is “UPntID_{—}0001” and the responsible staff member is “StfID_{—}0001”. Moreover, the patient of patient ID “PntID_{—}0001” expresses that information is shared between the establishments of the establishment IDs of “FclID_{—}0001” and “FclID_{—}0002”. Furthermore, in the example in FIG. 9, the shared patient ID is not set to the patient of patient ID “PntID_{—}0002”. This is the case where the establishment of the patient is in cooperation with an establishment whose associated establishment ID is not registered on the message control system 10, for example. Namely, the message control system 10 according to the embodiment can also control establishments independently in cooperation with the establishments.

Again referring to FIG. 4, the staff member information table 42 is a table that stores information about staff members belonging to the establishment.

FIG. 10 is a diagram of an exemplary data configuration of the staff member information table of Establishment F. As illustrated in FIG. 10, the staff member information table 42 includes entries of a “staff member ID”, “name”, and “occupational category”.

The entry of the staff member ID is a region that stores the staff member ID of a staff member given by the establishment. The entries of the name and the occupational category are regions that store the name and occupational category of a staff member. In the example in FIG. 10, the staff member of staff member ID “StfID_{—}0001” expresses that the staff member is “X” and the occupational category is a “doctor”.

Again referring to FIG. 4, the establishment information table 43 is a table that stores information about establishments between which messages can be linked by the message control system 10. For example, the establishment information table 43 stores information about the establishments that share information about a patient by the message control system 10. Moreover, the establishment information table 43 can also register information about establishments independently in cooperation with the establishment using a system other than the message control system 10.

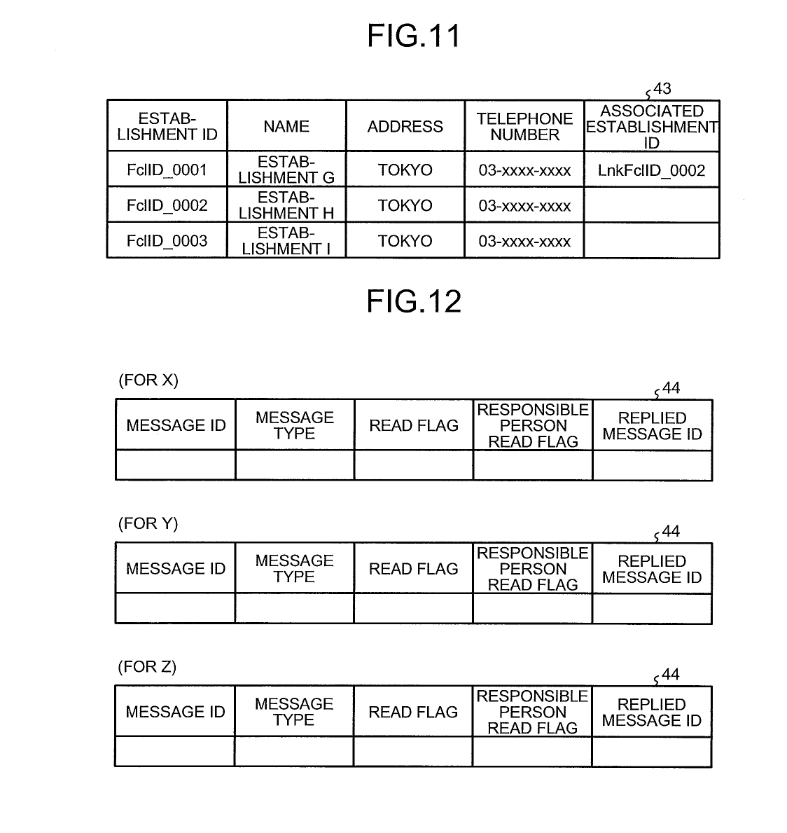

FIG. 11 is a diagram of an exemplary data configuration of the establishment information table of Establishment F. As illustrated in FIG. 11, the establishment information table 43 includes entries of an “establishment ID”, “name”, “address”, “telephone number”, and “associated establishment ID”.

The entry of the establishment ID is a region that stores identification information about the other establishments to the establishment. In the message control system 10 according to the embodiment, the establishments are enabled to give original establishment IDs as identification information to the other establishments. The entry of the establishment ID stores the establishment IDs of the other establishments to the establishment. It is noted that the associated establishment ID may be used for the establishment IDs of the other establishments to the establishment. The entries of the name, address, and telephone number are regions that store the establishment name, the location of the establishment, and the telephone number of the establishment. The entry of the associated establishment ID is a region that stores the associated establishment ID of the establishment. The entry of the associated establishment ID stores the associated establishment ID in the case where the message control system 10 gives the associated establishment ID. In the example in FIG. 11, the establishment of establishment ID “FclID_{—}0001” expresses that the name is “Establishment G”, the location is in “Tokyo”, the telephone number is “03-xxxx-xxxx”, and the associated establishment ID is “LnkFclID_{—}0002”. Moreover, in the example in FIG. 11, the establishments of establishment ID “FclID_{—}0002” and establishment ID “FclID_{—}0003” express that the establishments are independently in cooperation with each other because the associated establishment IDs are not set.

Again referring to FIG. 4, the personal message control table 44 is a table that stores information about messages sent to staff members.

FIG. 12 is a diagram of an exemplary data configuration of the personal message control table of Establishment F. The personal message control table 44 is individually generated for staff members. The example in FIG. 12 illustrates the personal message control tables 44 generated for Staff members X, Y, and Z. The personal message control table 44 includes entries of a “message ID”, “message Type”, “Read Flag”, “Responsible person read Flag”, and “Replied message ID”.

The entry of the message ID is a region that stores the message ID of a message. The entry of the message Type is a region that stores the determination whether the message is sent addressed to an individual person who is a staff member or the message is sent in common to a plurality of staff members. The entry of the message Type stores “personal” in the case where the message is sent addressed to an individual person who is a staff member, whereas the entry of the message Type stores “Group” in the case where the message is sent in common to a plurality of staff members. The entry of the read Flag is a region that stores the determination whether the message is read. The entry of the read Flag stores “True” in the case where the message is read, whereas the entry of the read Flag stores “False” in the case where the message is not read. The entry of the responsible person read Flag is a region that stores the determination whether the responsible person has read the message. The entry of the responsible person read Flag stores “True” in the case where the responsible person has read the message, whereas the flag stores “False” in the case where the responsible person does not read the message. The entry of the replied message ID is a region that stores the message ID of a replied message in the case where a reply is made to the message.

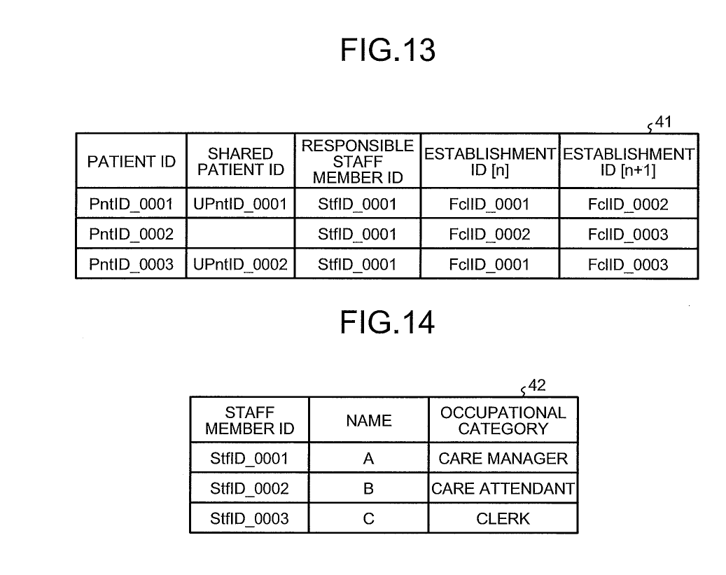

Next, exemplary items of data stored on the establishment DB 40G will be described with reference to FIGS. 13 to 16. FIG. 13 is a diagram of an exemplary data configuration of the patient information table of Establishment G. The data configuration of the patient information table 41 of Establishment G is similar to FIG. 9. In the example in FIG. 13, the patient of patient ID “PntID_{—}0001” expresses that the shared patient ID is “UPntID_{—}0001” and the responsible person is “StfID_{—}0001”. Moreover, the patient of patient ID “PntID_{—}0001” expresses that information about the patient is shared between the establishments whose establishment IDs are “FclID_{—}0001” and “FclID_{—}0002”.

FIG. 14 is a diagram of an exemplary data configuration of the staff member information table of Establishment G. The data configuration of the staff member information table 42 of Establishment G is similar to FIG. 10. In the example in FIG. 14, the staff member of staff member ID “StfID_{—}0001” expresses that the staff member is “A” and the occupational category is a “care manager”.

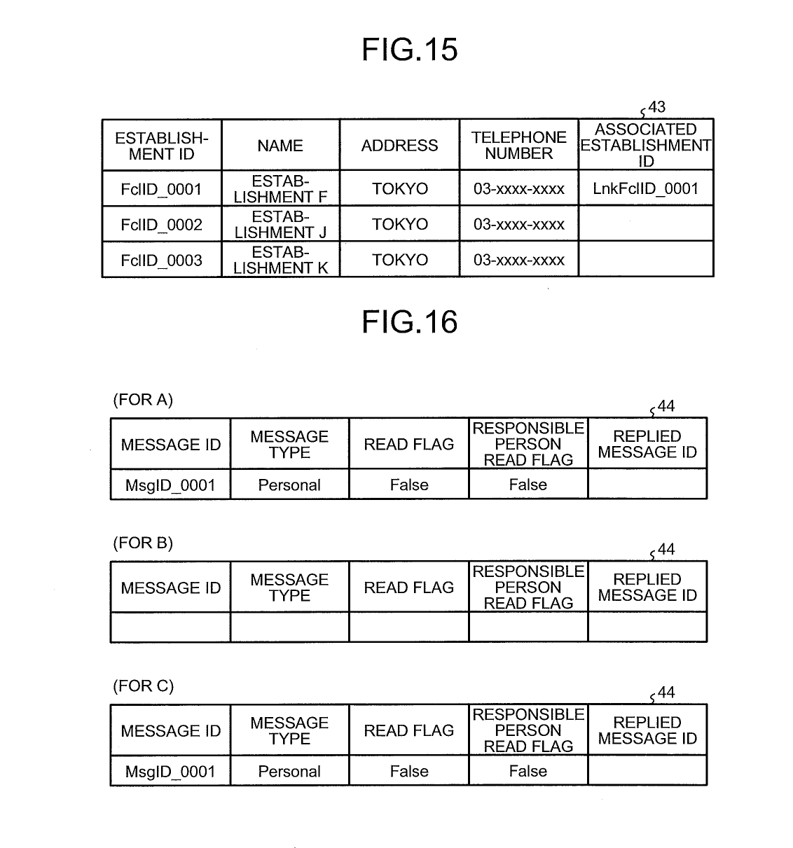

FIG. 15 is a diagram of an exemplary data configuration of the establishment information table of Establishment G. The data configuration of the establishment information table 43 of Establishment G is similar to FIG. 11. In the example in FIG. 15, the establishment of associated establishment ID “FclID_{—}0001” expresses that the name is “Establishment F”, the location is in “Tokyo”, the telephone number is “03-xxxx-xxxx”, and the associated establishment ID is “LnkFclID_{—}0001”.

FIG. 16 is a diagram of an exemplary data configuration of the personal message control table of Establishment G. The example in FIG. 16 illustrates the personal message control tables 44 individually generated for Staff members A, B, and C. The data configuration of the personal message control table 44 of Establishment G is similar to FIG. 12. In the example in FIG. 16, the message of message ID “MsgID_{—}0001” expresses that the message is addressed to an individual person and the message is unread because both of the read Flag and the responsible person read Flag are “False”. Moreover, the message of message ID “MsgID_{—}0001” expresses that a reply is not made to the message because a replied message is not set.

Again referring to FIG. 4, the processing unit 21 is a function unit that processes various items of data. The processing unit 21 is an electronic circuit of a server computer on which the message control system 10 operates such as a CPU (Central Processing Unit) and a MPU (Micro Processing Unit). The processing unit 21 performs various processes by executing a program prescribing various process procedures on an electronic circuit. The processing unit 21 functions as various processing units by operating various programs. For example, the processing unit 21 includes a display processing unit 50, an outgoing message processing unit 51, a removing unit 52, and an updating unit 53 as processing units.

The display processing unit 50 controls displaying images on the terminal device 11. For example, the display processing unit 50 generates screen information about various screens in response to various requests from the terminal device 11 and sends the information to the terminal device 11. Thus, various screens are displayed on the terminal device 11 based on the received screen information. For an example, in the case where the terminal device 11 makes an access request, the display processing unit 50 generates and sends screen information about a login screen to the terminal device 11. The login screen is provided with regions to which the establishment ID and the staff member ID are inputted. In the case where the establishment ID and the staff member ID are specified and a predetermined manipulation such as login is made on the login screen, the display processing unit 50 generates and sends screen information about a message sending and receiving screen to the terminal device 11. On the message sending and receiving screen, messages sent from the other staff members can be displayed in a list, and the messages can be confirmed and replied. Moreover, on the message sending and receiving screen, unread messages can be extracted and displayed in a list on an unread message list screen. Furthermore, on the message sending and receiving screen, sent messages can be extracted and displayed in a list on an outgoing message list screen.

The outgoing message processing unit 51 is a processing unit that performs various processes for sending messages. The outgoing message processing unit 51 includes a setting unit 54 and an adding unit 55. In the case where a message is generated and instructed to send, the outgoing message processing unit 51 sends the message instructed to send.

For example, in the message control system 10 according to the embodiment, it is enabled that the establishment ID and the patient ID which are addressees are specified and a message addressed to a group is sent. It is noted that the establishment ID which is an addressee may be the associated establishment ID, may be an establishment ID original in the establishment, or may be internally converted into the associated establishment ID by the message control system 10. The patient ID which is an addressee may be the shared patient ID, a patient ID original in the establishment, or may be internally converted into the shared patient ID by the message control system 10. In the case where a message addressed to a group is instructed to send, the setting unit 54 sets the responsible person of the message based on information extracted from the message created and addressed to a group. For example, the setting unit 54 extracts information about the establishment ID and the patient ID which are addressees from the message instructed to send. The setting unit 54 identifies the staff member ID of a responsible person and the staff member IDs of staff members other than the responsible person at the establishments from the extracted establishment ID and the patient ID based on the establishments DB 40.

The adding unit 55 adds the message to the message lists of a plurality of members who are addressees. For example, the adding unit 55 registers the message instructed to send together with information about the sender and information about the addressees on the message control table 33. When any one of a plurality of the members first makes a receive request of a message, the adding unit 55 then registers arrival information about the message stored on the message control table 33 on the message control table for the individual members. Namely, the adding unit 55 distributes the message whose addressee is the establishment ID and the patient ID to the responsible person and the staff members other than the responsible person. Thus, the distributed message is additionally displayed on the unread message list screens of the staff members.

The removing unit 52 removes a message from the message lists of the staff members expect the responsible person according to the confirmation of the message by the responsible person. For example, in the case where the responsible person confirms mail, the removing unit 52 removes a message from the unread message list screens of the staff members other than the responsible person.

The updating unit 53 updates the confirmation notification status of the message at the sender of the message according to the confirmation of the message by the responsible person. For example, the outgoing message list screen can display the situations of confirmation of the sent message. The updating unit 53 updates the confirmation notification status of the message on the outgoing message list screen according to the confirmation of the message by the responsible person.

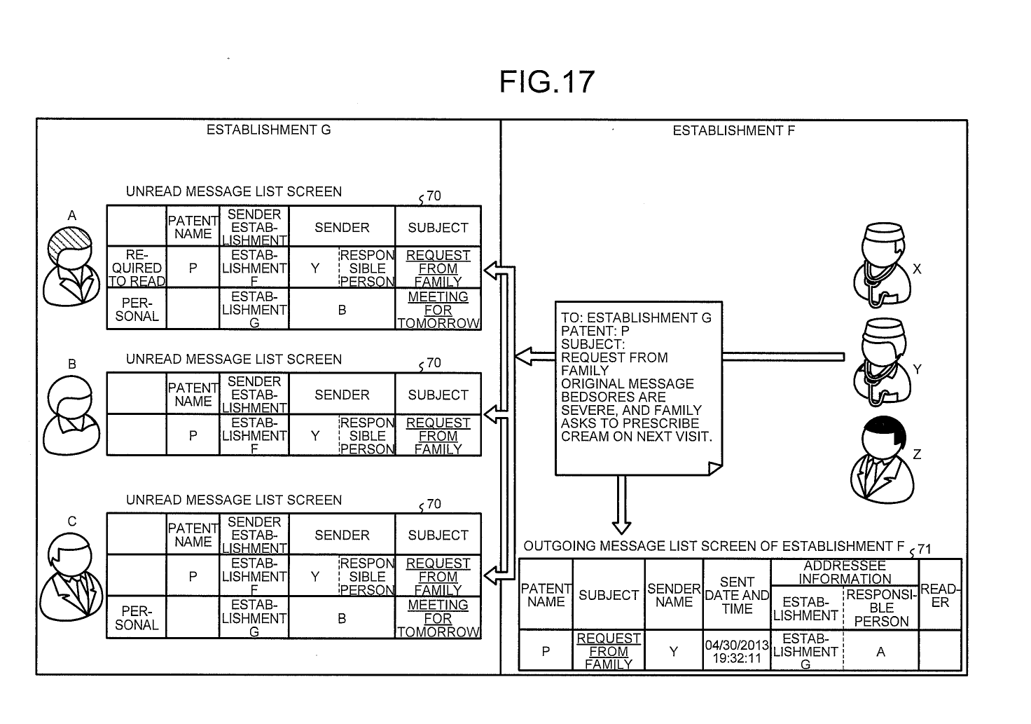

Here, an exemplary display screen displayed by the message control system 10 according to the embodiment will be described. FIG. 17 is a diagram of an exemplary display screen when sending a message. In the example in FIG. 17, an example is illustrated where an unread message list screen 70 is displayed at Establishment G. Moreover, in the example in FIG. 17, the case is illustrated where Staff member Y at Establishment F specifies Establishment G and Patient P and sends a message. For example, in the case where data illustrated in FIGS. 5 to 16 is stored on the shared DB 30, the establishment DB 40F, and the establishment DB 40G, messages addressed to individual persons are displayed on the unread message list screens 70 of Staff members A and C at Establishment G. For example, the entry of “personal” is displayed on the unread message list screen 70 of Staff member A, “Establishment G” is displayed on the sender establishment, “B” is displayed on the sender, and “meeting for tomorrow” is displayed on the subject.

In the case where Staff member Y at Establishment F specifies Establishment G and Patient P and sends a message, the setting unit 54 extracts information about the establishment ID and the patient ID which are addressees from the sent message. The setting unit 54 then identifies the staff member ID of a responsible person and the staff member IDs of staff members other than the responsible person at the establishments from the extracted establishment ID and the patient ID based on the establishments DB 40. For example, in the example in FIG. 17, Staff member A is identified as a responsible person, Staff members B and C are identified as staff members other than the responsible person. The adding unit 55 adds the message to the message lists of a plurality of the members who are addressees. For example, for example, the adding unit 55 registers the message instructed to send together with information about the sender and information about the addressees on the message control table 33. When any one of a plurality of the members first makes a receive request of the message, the adding unit 55 then registers the message stored on the message control table 33 on the message control table 33 for the individual members. Thus, in the example in FIG. 17, the message sent from Staff member Y at Establishment F is added to the unread message list screens of Staff members A, B, and C. The display processing unit 50 indicates the responsible person on the message list of the staff member who is a responsible person, and displays the message. For example, the display processing unit 50 displays “required to read” indicating the responsible person on the unread message list screen of Staff member A. Thus, Staff member A can determine that Staff member A is a responsible person.

Moreover, in the example in FIG. 17, an example is illustrated where an outgoing message list screen 71 is displayed at Establishment F. For example, on the outgoing message list screen 71, “P” is displayed on the patient, “request from the family” is displayed on the subject, “Y” is displayed on the sender, and “2013/04/30 19:32:11” is displayed on the sent date and time, “Establishment G” is displayed on the establishment of addressee information, and “A” is displayed on the responsible person. Here, after sending the message, the display processing unit 50 displays the responsible person at the addressee establishment on the outgoing message list screen 71. Thus, the staff members at Establishment F can determine that the responsible person for Patient P is Staff member A at Establishment G.

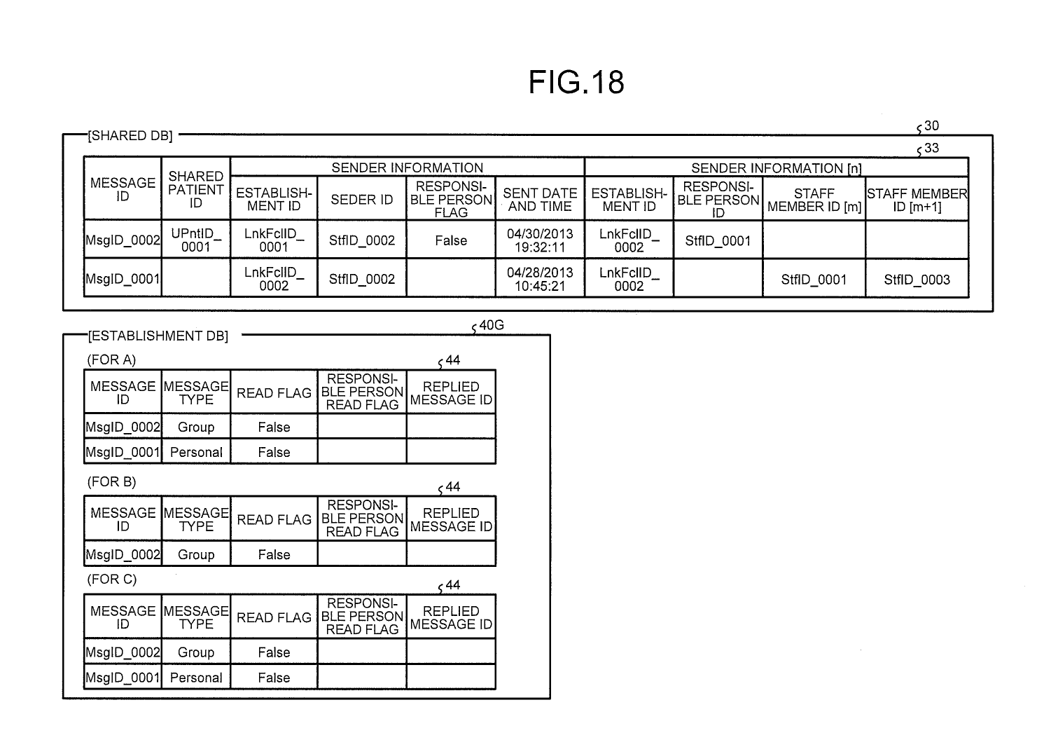

FIG. 18 is a diagram of an exemplary change in data due to sending the message illustrated in FIG. 17. FIG. 18 illustrates the message control table 33 of the shared DB 30 and the personal message control tables 44 of Staff members A, B, and C of the establishment DB 40G. The message illustrated in FIG. 17 is sent, and the record of message ID “MsgID_{—}0002” is added to the message control table 33 as compared with FIG. 7. Moreover, the record of message ID “MsgID_{—}0002” is added to the personal message control tables 44 of Staff members A, B, and C as well as compared with FIG. 16.

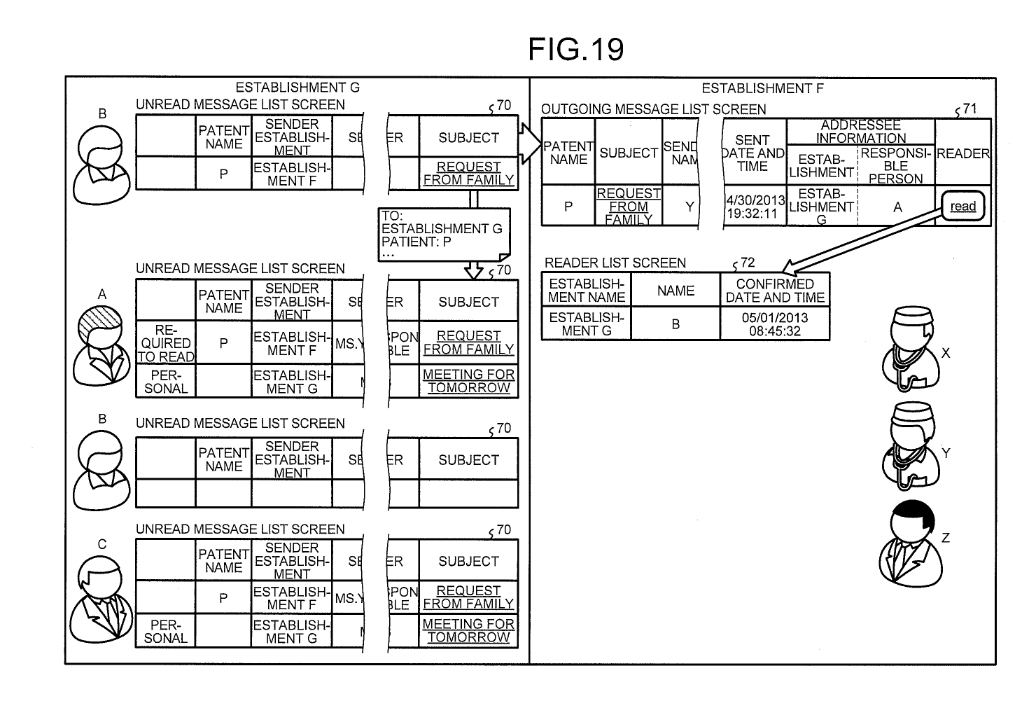

FIG. 19 is a diagram of an exemplary display screen when a staff member other than a responsible person confirms a message. In the example in FIG. 19, the case is illustrated where Staff member B confirms a message on Patient P at Establishment G. In the case where Staff member B confirms a message on Patient P on the unread message list screen 70, the message on Patient P is not displayed on the unread message list screen 70 of Staff member B. On the other hand, the message on Patient P is displayed on the unread message list screens 70 of Staff members A and C. For example, even in the case where Staff member A is absent and a staff member other than the responsible person confirms the message on Patient P of whom Staff member A is in charge, the message is displayed on the unread message list screen 70 of Staff member A. Thus, even in the case where a staff member other than the responsible person already confirms the message on Patient P of whom Staff member A is in charge, Staff member A can confirm the message through the unread message list screen 70.

Moreover, in the example in FIG. 19, an example is illustrated where the outgoing message list screen 71 is displayed at Establishment F. For example, “read” is displayed on the entry of the reader on the outgoing message list screen 71. This “read” is selected, and a reader list screen 72 is displayed. The reader list screen 72 displays that Staff member B at Establishment G confirms the message on 2013/05/01 at 8:45:32. Thus, the staff member at Establishment F can know a staff member who confirms the message.

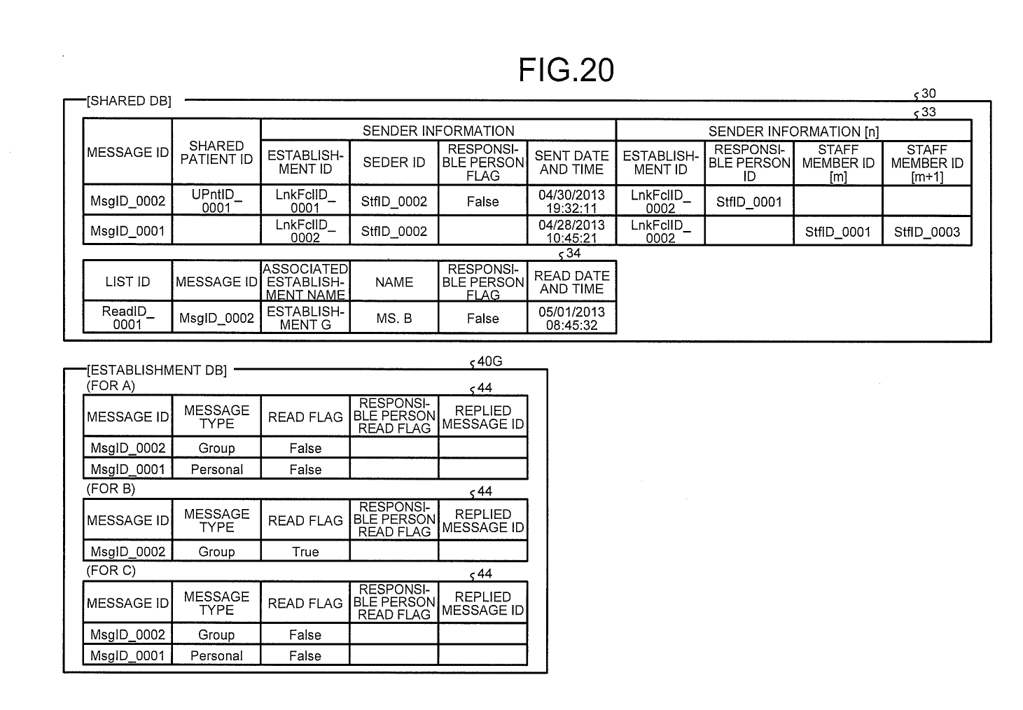

FIG. 20 is a diagram of an exemplary change in data due to confirming the message illustrated in FIG. 19. FIG. 20 illustrates the message control table 33 and the message reader table 34 of the shared DB 30 and the personal message control tables 44 of Staff members A, B, and C of the establishment DB 40G. The message illustrated in FIG. 19 is confirmed, and a record indicating that Staff member B at Establishment G confirms the message of message ID “MsgID_{—}0002” is added to the message reader table 34. Moreover, the read Flag on the record of message ID “MsgID_{—}0002” is updated to “True” on the personal message control table 44 of Staff member B.

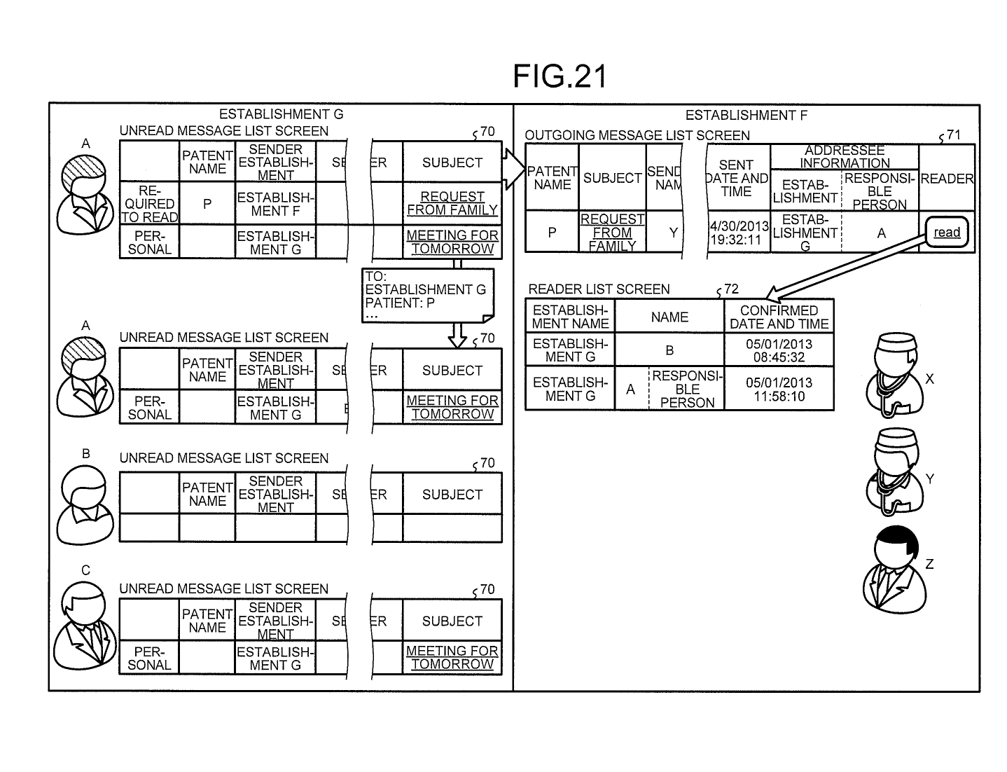

FIG. 21 is a diagram of an exemplary display screen when a responsible person confirms a message. In the example in FIG. 21, the case is illustrated where Staff member A confirms the message on Patient P of whom Staff member A is in charge at Establishment G. In the case where Staff member A confirms the message on Patient P of whom Staff member A is in charge on the unread message list screen 70, the message on Patient P is not displayed on the unread message list screen 70 of Staff member A. Moreover, the message on Patient P is removed and the message is not displayed on the unread message list screen 70 of Staff member C as well. Namely, in the case where Staff member A confirms the message on Patient P of whom Staff member A is in charge, the message is not displayed on the unread message list screens 70 of Staff members B and C other than a responsible person. Thus, in the message control system 10, Staff member A who is a responsible person confirms the message, so that it is possible to suppress that the message unnecessary to make a confirmation is left on the unread message list screens 70 of Staff members B and C.

Furthermore, in the example in FIG. 21, an example is illustrated where the outgoing message list screen 71 is displayed at Establishment F. For example, “read” is displayed on the entry of the reader on the outgoing message list screen 71. This “read” is selected, and a reader list screen 72 is displayed. The reader list screen 72 displays that Staff member B at Establishment G confirms the message on 2013/05/01 at 8:45:32. In addition, the reader list screen 72 displays that Staff member A who is a responsible person at Establishment G confirms the message on 2013/05/01 at 11:58:10. Thus, the staff member at Establishment F can know whether the responsible person confirms the message.

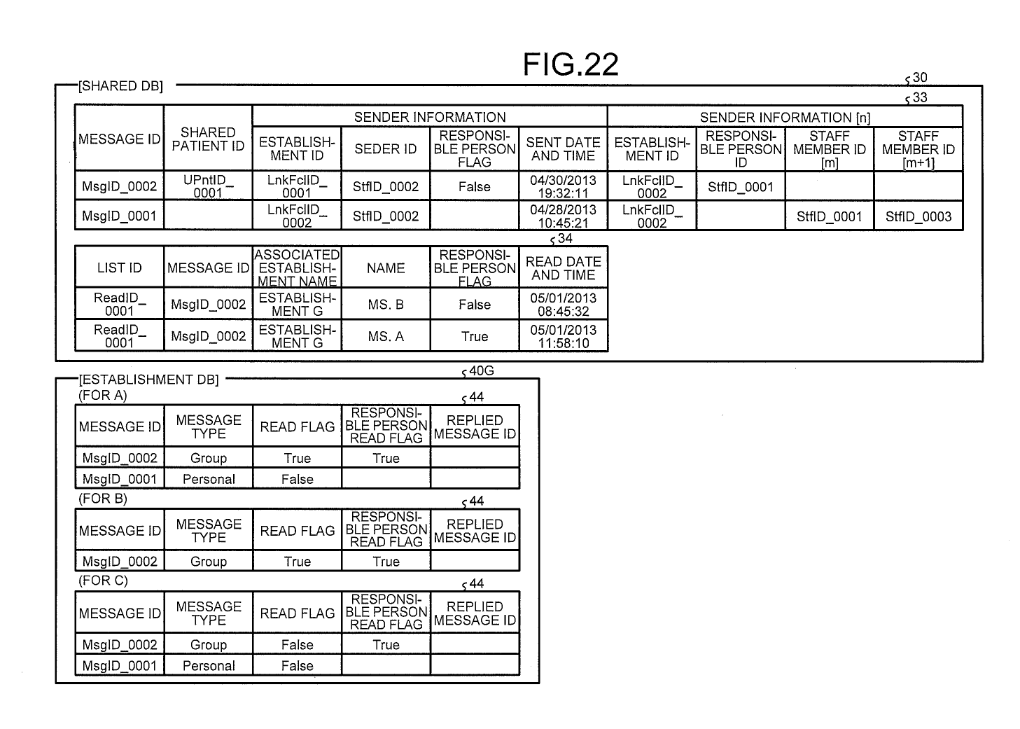

FIG. 22 is a diagram of an exemplary change in data due to confirming the message illustrated in FIG. 21. FIG. 22 illustrates the message control table 33 and the message reader table 34 of the shared DB 30 and the personal message control tables 44 of Staff members A, B, and C of the establishment DB 40G. The message illustrated in FIG. 21 is confirmed, and a record indicating that Staff member A at Establishment G confirms the message of message ID “MsgID_{—}0002” is added to the message reader table 34. Moreover, on the personal message control table 44 of Staff member A, the read Flag of the record of message ID “MsgID_{—}0002” and the responsible person read Flag are updated to “True”. Furthermore, on the personal message control tables 44 of Staff members B and C, the responsible person read Flag on the record of message ID “MsgID_{—}0002” is updated to “True”. As described above, in the case where the responsible person read Flag is updated to “True”, the message is not displayed on the unread message list screen 70.

Process Flows

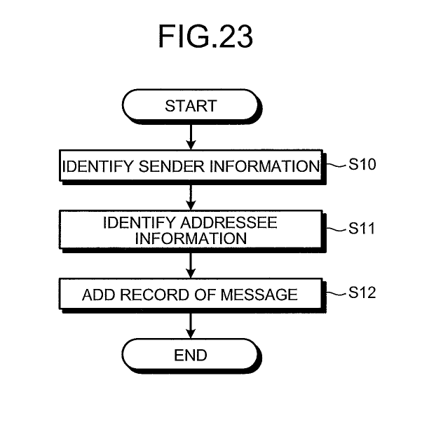

Next, various process flows of the message control system 10 according to the embodiment will be described. First, a flow of a message transmission process for sending messages by the message control system 10 according to the embodiment will be described. FIG. 23 is a flowchart of exemplary procedures of the message transmission process. This message transmission process is performed at the timing of making a predetermined manipulation that specifies sending a message on the message sending and receiving screen.

As illustrated in FIG. 23, the outgoing message processing unit 51 identifies various items of information to be stored on the entry of sender information for a message instructed to send (step S10). For example, the outgoing message processing unit 51 identifies the associated establishment ID of the establishment to which a message is instructed to send as the establishment ID to be stored on the entry of the establishment on the entry of sender information. Moreover, the outgoing message processing unit 51 identifies the staff member ID of the staff member who instructs sending the message as the staff member ID to be stored on the entry of the sender ID on the entry of sender information. Furthermore, in the case where the patient ID is specified as an addressee, the outgoing message processing unit 51 determines whether the staff member who instructs sending the message is a responsible person. For example, the outgoing message processing unit 51 determines whether the staff member ID of the staff member who instructs sending the message is registered on the record of the patient ID of an addressee on the patient information table 41 of the sender establishment. In the case where the staff member ID is registered, the outgoing message processing unit 51 identifies that “True” is stored on the entry of the responsible person Flag on the entry of sender information, whereas in the case where the staff member ID is not registered, the outgoing message processing unit 51 identifies that “False” is stored on the entry of the responsible person Flag on the entry of sender information. In addition, the outgoing message processing unit 51 identifies the shared patient ID corresponding to the patient ID of an addressee from the patient information table 41. Moreover, the outgoing message processing unit 51 identifies the date and time on which sending is specified as the date and time to be stored on the entry of the sent date and time on the entry of sender information.

Subsequently, the outgoing message processing unit 51 identifies various items of information to be stored on the entry of addressee information for the message instructed to send (step S11). For example, in the case where the establishment ID and the patient ID are specified as an addressee, the outgoing message processing unit 51 identifies the establishment ID of an addressee as the establishment ID to be stored on the entry of the establishment on the entry of addressee information. The setting unit 54 identifies the staff member ID of the responsible person for the individual establishments of an addressee from the establishment ID of an addressee and the shared patient ID corresponding to the patient ID of an addressee based on the patient information tables 41 of the establishments DB 40. The setting unit 54 then identifies the staff member ID of the responsible person as the staff member ID to be stored on the entry of the responsible person ID on the entry of addressee information for the individual establishments. Moreover, the setting unit 54 identifies the staff member IDs of staff members other than the responsible person for the individual establishments. The setting unit 54 then identifies the staff member IDs of the staff members other than the responsible person as the staff member IDs to be stored on the entry of the staff member ID on the entry of addressee information for the individual establishments. On the other hand, in the case where the establishment ID and the staff member ID are specified as an addressee, the outgoing message processing unit 51 identifies the establishment ID of an addressee as the establishment ID to be stored on the entry of the establishment on the entry of addressee information. Furthermore, the outgoing message processing unit 51 turns the entry of the responsible person ID on the entry of addressee information to be unset, and identifies the addressee staff member ID as the staff member ID to be stored on the entry of the staff member ID on the entry of addressee information.

The outgoing message processing unit 51 then adds the record of the message in which various items of information identified in steps S10 and S11 described above to the message control table 33 (step S12), and ends the process.

By this message transmission process, in the message control system 10, the record, on which information about the message instructed to send is set, is added to the message control table 33.

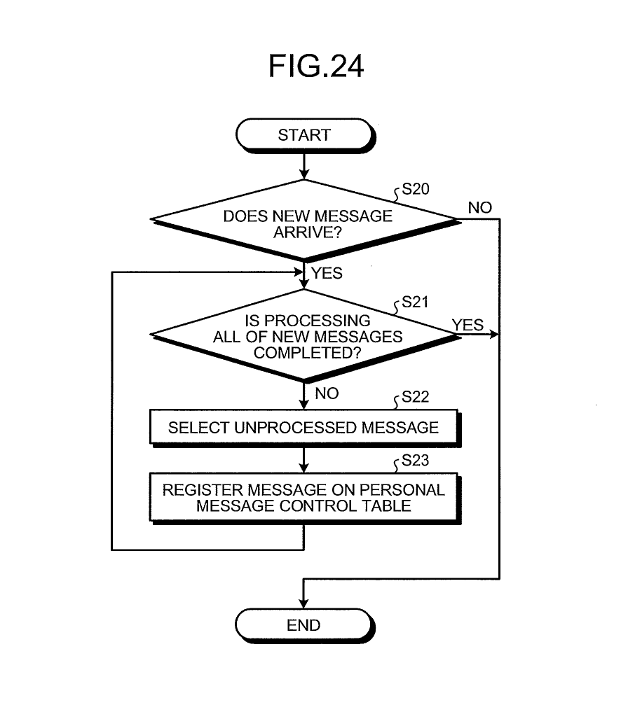

Next, a flow of a message distribution process for distributing a message to the staff member of an addressee by the message control system 10 according to the embodiment will be described. FIG. 24 is a flowchart of exemplary procedures of the message distribution process. This message distribution process is performed at the timing at which the staff member logs in and the timing at which a predetermined manipulation is performed to instruct confirmation of a received message on the message sending and receiving screen.

The outgoing message processing unit 51 determines whether a new message arrives for a user who logs in at the establishment (step S20). For example, the outgoing message processing unit 51 finds records from the message control table 33 that the establishment ID of the establishment that logs in and the user ID of the user who logs in are stored on the entry of addressee information. The outgoing message processing unit 51 then identifies a record that the message ID is not registered on the personal message control table 44 of the user who logs in at the establishment as a new message in the found records. In the case where a new message does not arrive (No in step S20), the outgoing message processing unit 51 ends the process.

On the other hand, in the case where a new message arrives (Yes in step S20), the outgoing message processing unit 51 determines whether processing all of new messages is completed (step S21). In the case where processing is completed (Yes in step S21), the outgoing message processing unit 51 ends the process.

On the other hand, in the case where processing is not completed (No in step S21), the adding unit 55 selects an unprocessed new message as a message targeted for processing (step S22). The adding unit 55 adds the record of the message targeted for processing to the personal message control table 44 of the staff member of an addressee (step S23). For example, the adding unit 55 adds the record of the message ID to the personal message control tables 44 of the staff members on which the staff member ID is stored on the entry of the responsible person and the entry of the staff member ID for the establishments at which the establishment ID is stored on the entry of the establishment on the entry of addressee information. In the adding, the adding unit 55 sets “Group” to the entry of the message Type for the message that the patient ID is stored on the entry of the shared patient ID of the message control table 33, whereas the adding unit 55 sets “Personal” to the entry of the message Type for the message that the patient ID is not stored. Moreover, the adding unit 55 sets “False” to the entry of the read Flag and the entry of the responsible person read Flag, and makes the entry of the replied message ID blank. When adding the record is completed, the process goes to step S21 described above.

By this message distribution process, in the message control system 10, the message is distributed to the staff member of an addressee. Moreover, in the message control system 10, any one of staff members of addressees first makes a request to receive the message, the message is individually registered on the personal message control tables 44 of the staff members of addressees. Namely, the message control system 10 distributes the message to the staff members of addressees at the timing at which a request to receive the message is first made, not at the timing at which sending the message is instructed. The message control system 10 distributes the message to the staff members of addressees at the timing at which a request is made to receive the message, so that it is possible to reduce a load on processing at the timing at which sending the message is instructed.

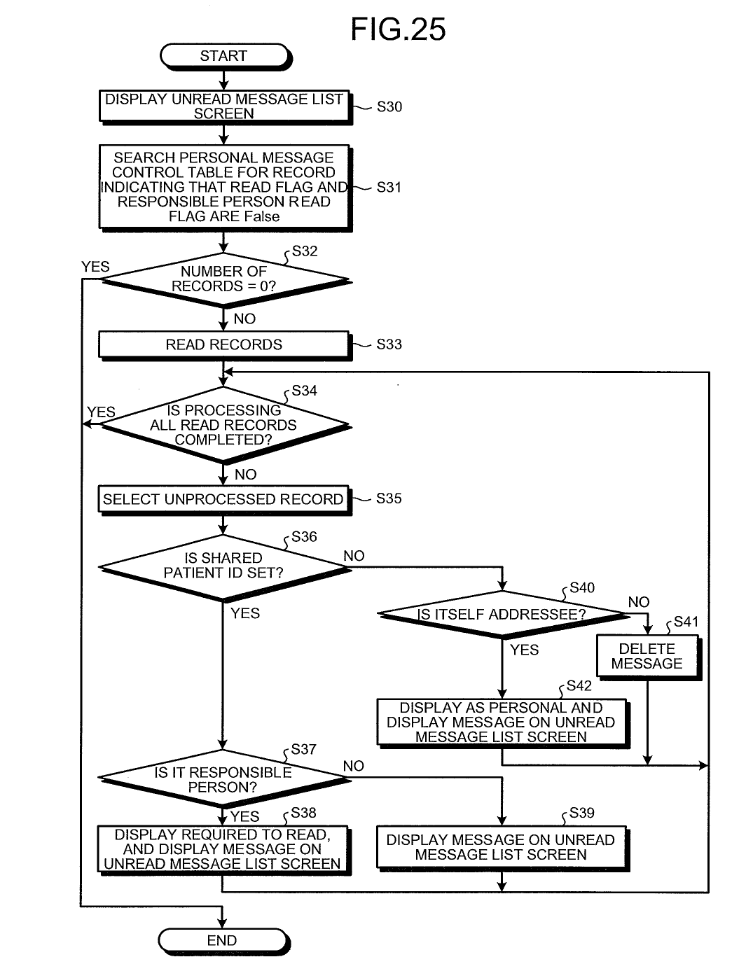

Next, a flow of an unread message list display process for displaying an unread message list in the message control system 10 according to the embodiment will be described. FIG. 25 is a flowchart of exemplary procedures of the unread message list display process. The unread message list display process is performed at the timing of making a predetermined manipulation that instructs displaying the unread message list screen. It is noted that suppose that the establishment ID to which the staff member manipulating the image belongs and the staff member IDs of the staff members are identified by a login on the login screen.

The display processing unit 50 displays the unread message list screen (step S30). Subsequently, the display processing unit 50 searches the personal message control table 44 of the staff member manipulating the image for a record indicating that the entry of the read Flag and the entry of the responsible person read Flag are “False” (step S31).

The display processing unit 50 determines whether the number of records found is zero (step S32). In the case where the number of the records is zero (Yes in step S32), the display processing unit 50 ends the process.

On the other hand, in the case where the number of the records is not zero (No in step S32), the display processing unit 50 reads the found record of the message ID out of the message control table 33 (step S33). The display processing unit 50 determines whether processing all the read records is completed (step S34). In the case where processing is completed (Yes in step S34), the display processing unit 50 ends the process.

On the other hand, in the case where processing is not completed (No in step S34), the display processing unit 50 selects an unprocessed record as a record targeted for processing (step S35). The display processing unit 50 determines whether the patient ID is set to the entry of the shared patient ID on the record targeted for processing (step S36). In the case where the patient ID is set to the entry of the shared patient ID (Yes in step S36), the display processing unit 50 determines whether the staff member manipulating the image is a responsible person (step S37). For example, in the case where the staff member ID of the staff member manipulating the image is set to the record targeted for processing that the establishment ID to which the staff member manipulating the image belongs is set to the entry of the responsible person ID on the entry of addressee information, the display processing unit 50 determines that it is a responsible person. It is noted that the display processing unit 50 may determine whether it is a responsible person based on the patient information table 41 of the establishment to which the staff member manipulating the image belongs. In the case where it is a responsible person (Yes in step S37), the display processing unit 50 displays “required to read”, and additionally displays the message on the unread message list screen (step S38), and goes to step S34 described above. On the other hand, in the case where it is not a responsible person (No in step S37), the display processing unit 50 additionally displays the message on the unread message list screen (step S39), and goes to step S34 described above.

On the other hand, in the case where the patient ID is not set to the entry of the shared patient ID (No in step S36), the display processing unit 50 determines whether the display processing unit 50 is an addressee message (step S40). For example, in the case where the staff member ID of the staff member manipulating the image is set to the record targeted for processing that the establishment ID of the staff member manipulating the image is set to the entry of the staff member ID on the entry of addressee information, the display processing unit 50 determines that the display processing unit 50 is an addressee message. In the case where the display processing unit 50 is not an addressee message (No in step S40), the display processing unit 50 deletes the record of the message from the personal message control table 44 (step S41), and goes to step S34 described above. On the other hand, in the case where the display processing unit 50 is an addressee message (Yes in step S40), the display processing unit 50 displays “personal”, and additionally displays the message on the unread message list screen (step S42), and goes to step S34 described above.

By the unread message list display process, in the message control system 10, the message that the staff member manipulating the image is not confirmed and the responsible person is not confirmed as well is displayed on the unread message list screen. Thus, the message control system 10 can display the message that the staff member has to confirm on the unread message list screen.

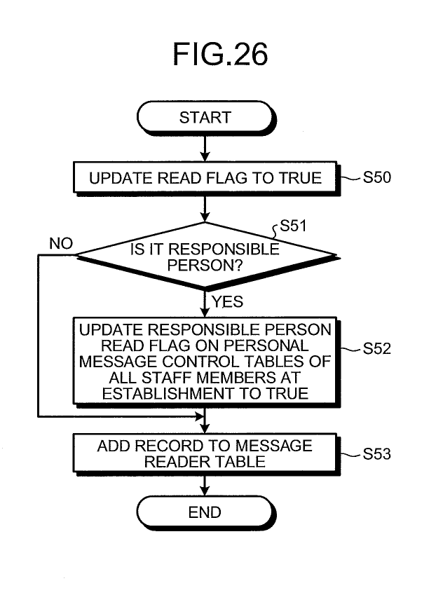

Next, a flow of a flag update process for updating the flag when a reference is made to an unread message by the message control system 10 according to the embodiment will be described. FIG. 26 is a flowchart of exemplary procedures of the flag update process. This flag update process is performed at the timing of making a predetermined manipulation that instructs making a reference to an unread message. It is noted that suppose that the establishment ID to which the staff member manipulating the image belongs and the staff member IDs of the staff members are identified by a login on the login screen.

The removing unit 52 updates the entry of the read Flag of a message to which a reference is made to “True” on the personal message control table 44 of the staff member manipulating the image (step S50). The removing unit 52 determines whether the staff member manipulating the image is a responsible person (step S51). For example, the removing unit 52 determines whether the staff member manipulating the image is a responsible person based on the patient information table 41 of the establishment to which the staff member manipulating the image belongs. In the case where it is not a responsible person (No in step S51), the removing unit 52 goes to the process in step S53 described later.

On the other hand, in the case where it is a responsible person (Yes in step S51), the removing unit 52 updates the entry of the responsible person read Flag of the message to which a reference is made to “True” on the personal message control tables 44 of all the staff members at the establishment to which the staff member manipulating the image belongs (step S52). The updating unit 53 additionally updates the record indicating that a reference is made to the message by the staff member manipulating the image on the message reader table 34 (step S53), and ends the process.

By this flag update process, in the message control system 10, the message that the staff member confirms by himself/herself and the message that the responsible person confirms are removed, and not displayed on the unread message list screen. Thus, the message control system 10 can suppress that messages unnecessary to make a confirmation are left on the unread message list screen.

Moreover, in the message control system 10, the record indicating that a reference is made to the message is added to the message reader table 34, and the confirmation notification status of the message is updated.

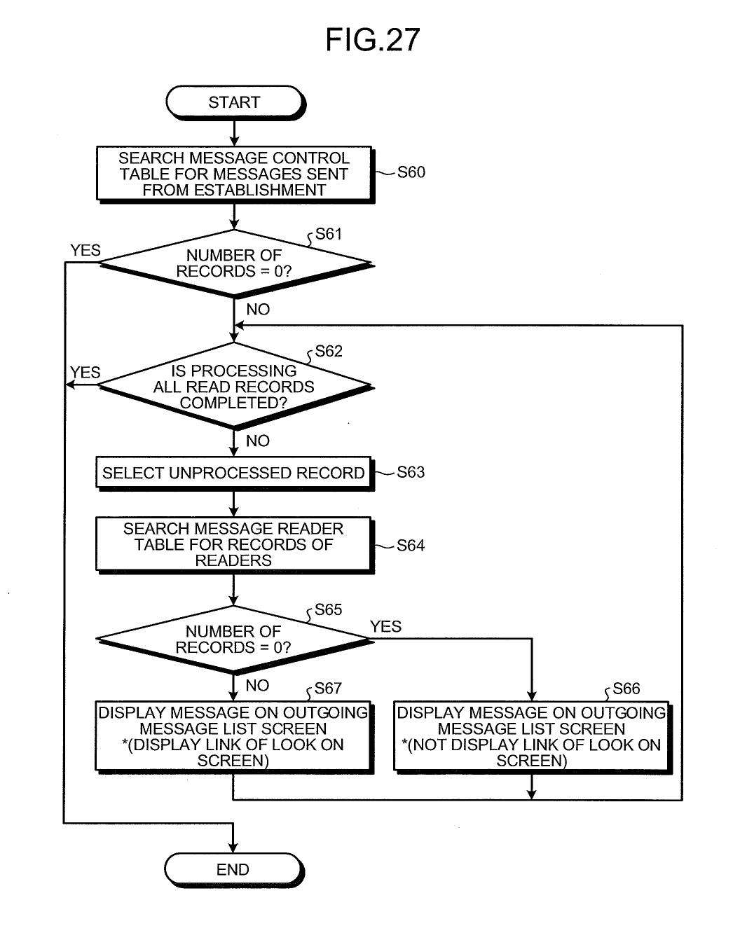

Next, a flow of an outgoing message list display process for displaying the outgoing message list screen by the message control system 10 according to the embodiment the will be described. FIG. 27 is a flowchart of exemplary procedures of the outgoing message list display process. The outgoing message list display process is performed at the timing of making a predetermined manipulation that instructs displaying the outgoing message list screen. It is noted that suppose that the establishment ID to which the staff member manipulating the image belongs and the staff member IDs of the staff members are identified by a login on the login screen.

The display processing unit 50 searches the message control table 33 for messages sent from the establishment to which the staff member manipulating the image belong (step S60). The display processing unit 50 determines whether the number of records found is zero (step S61). In the case where the number of the records is zero (Yes in step S61), the display processing unit 50 ends the process.

On the other hand, in the case where the number of the records is not zero (No in step S61), the display processing unit 50 determines whether processing all the found records is completed (step S62). In the case where processing is completed (Yes in step S62), the display processing unit 50 ends the process.

On the other hand, in the case where processing is not completed (No in step S62), the display processing unit 50 selects an unprocessed record as a record targeted for processing (step S63). The display processing unit 50 searches the message reader table 34 for the records of the readers of the message on the record targeted for processing (step S64). For example, the display processing unit 50 searches the message reader table 34 for the records that the message ID of the record targeted for processing is set. The display processing unit 50 determines whether the number of records found is zero (step S65). In the case where the number of the records is zero (Yes in step S65), the display processing unit 50 displays the message on the record targeted for processing on the outgoing message list screen (step S66), and goes to step S62 described above.

On the other hand, in the case where the number of the records is not zero (No in step S65), the display processing unit 50 displays the link of “read” to display the message on the record targeted for processing on the outgoing message list screen (step S67), and goes to step S62 described above.

By the outgoing message list display process, in the message control system 10, the outgoing message list screen is displayed. Thus, the message control system 10 can confirm whether the message is confirmed on the outgoing message list screen. Moreover, the message control system 10 can confirm the responsible person at the establishment of an addressee on the outgoing message list screen.

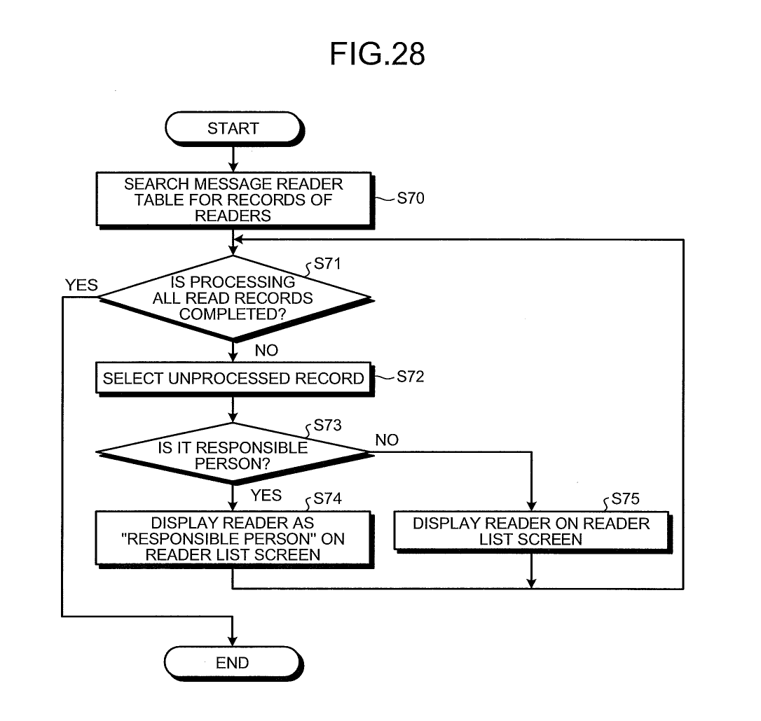

Next, a flow of a reader list display process for displaying the reader list screen by the message control system 10 according to the embodiment will be described. FIG. 28 is a flowchart of exemplary procedures of the reader list display process. The reader list screen display process is performed at the timing of making a manipulation that specifies the link of “read” displayed on the outgoing message list screen. It is noted that suppose that the establishment ID to which the staff member manipulating the image belongs and the staff member IDs of the staff members are identified by a login on the login screen. Moreover, suppose that the message ID of the message on which the link of “read” is specified is also identified.

The display processing unit 50 searches the message reader table 34 for the records of the readers of the message on which the link of “read” is specified (step S70). For example, the display processing unit 50 searches the message reader table 34 for the records that the message ID of the message on which the link of “read” is specified is set.

The display processing unit 50 determines whether displaying all the found records is completed (step S71). In the case where displaying is completed (Yes in step S71), the display processing unit 50 ends the process.

On the other hand, in the case where displaying is not completed (No in step S71), the display processing unit 50 selects the record not displayed as a record targeted for processing (step S72). The display processing unit 50 determines whether the reader of the record targeted for processing is a responsible person (step S73). For example, in the case where the entry of the responsible person Flag is “True” on the record targeted for processing, the display processing unit 50 determines that the reader is a responsible person. It is noted that the display processing unit 50 may determine whether it is a responsible person based on the patient information table 41 of the establishment to which the staff member manipulating the image belongs.

In the case where the reader is a responsible person (Yes in step S73), the display processing unit 50 displays the reader as a responsible person on the reader list screen (step S74), and goes to step S71 described above. On the other hand, in the case where the reader is not a responsible person (No in step S73), the display processing unit 50 displays the reader on the reader list screen (step S75), and goes to step S71 described above.

By the reader list display process, in the message control system 10, the staff member who confirms the message is displayed on the reader list screen. Thus, the message control system 10 can grasp the staff member who confirms the message

The Effect

As described above, the message control system 10 according to the embodiment sets the responsible person of the message from a plurality of the staff members at the establishment based on the patient ID extracted from the message created and addressed to the establishment. The message control system 10 adds the message to the list on the unread message list screens of a plurality of the staff members. The message control system 10 removes the message from the list on the unread message list screens of a plurality of the staff members except the responsible person according to the confirmation of the message by the responsible person. Thus, the message control system 10 can suppress that messages unnecessary to make a confirmation are left.

Moreover, the message control system 10 according to the embodiment updates the confirmation notification status of the message at the sender of the message according to the confirmation of the message by the responsible person. Thus, the message control system 10 confirms the status at the sender, so that the situations of confirmation of the message by the responsible person can be grasped.

Furthermore, the message control system 10 according to the embodiment registers the message created and addressed to the establishment on the message control table 33. The message control system 10 then registers the message stored on the message control table 33 on the personal message control table 44 for the individual members when any one of a plurality of the staff members first makes a request to receive the message. Thus, the message control system 10 can reduce a load on processing at the timing at which sending the message is instructed.

In addition, the message control system 10 according to the embodiment displays the message on the unread message list screen of the staff member who is a responsible person as it is a responsible person. Thus, the message control system 10 can grasp the message as it is a responsible person.

Moreover, the message control system 10 according to the embodiment displays the message of a certain case that the staff member at Establishment F creates as addressed to Establishment G on the outgoing message list screen in association with the responsible person at Establishment G corresponding to the certain case. Thus, the message control system 10 can grasp the responsible person at the other establishments.

Furthermore, the message control system 10 according to the embodiment is enabled to specify the establishment ID and the patient ID which are addressees and send the message addressed to the group. Thus, the message control system 10 can deliver the message even though the responsible person at the establishment of an addressee is unknown.

In addition, the message control system 10 identifies the staff member ID of the responsible person at the establishment from the establishment ID and the patient ID based on the establishment DB 40. Thus, the message can be delivered to the responsible person by updating the establishment DB 40 even though the responsible person is changed.

Moreover, for example, there is the case where when contact made with a doctor, for example, it is difficult to make a determination whether contact has to be made with a doctor depending on the content and it is psychologically reluctant to specify a doctor as an addressee and to send a message. Even in this case, the message control system 10 according to the embodiment sends a message addressed to the establishment without specifying individual responsible persons, and it is easy to send messages.

Furthermore, the message control system 10 according to the embodiment displays messages addressed to the establishment and the messages addressed to the individual persons in a list on the same message list. Thus, the message control system 10 according to the embodiment can confirm a received message by confirming a single message list, so that it is possible to suppress that a message is overlooked.

### [b] Second Embodiment

The embodiment of the disclosed apparatus is described so far. The disclosed technique may be implemented in various different forms other than the foregoing embodiment. Therefore, in the following, the other embodiments included in the present invention will be described.

For example, in the foregoing embodiment, the case is described where the responsible person who confirms the message and the staff members other than the responsible person are displayed in a list on the reader list screen. However, the disclosed apparatus is not limited thereto. For example, the display processing unit 50 may vary display forms between the case where confirmation is made by the responsible person and the case where confirmation is made by the staff member other than the responsible person. For example, the display processing unit 50 may vary display forms between the case where confirmation is made by the responsible person and the case where confirmation is made by the staff member other than the responsible person on the outgoing message list screen as colors, character sizes, character types, and background patterns, for example, are changed. Moreover, the display processing unit 50 may vary display forms between the record confirmed by the responsible person and the record confirmed by the staff member other than the responsible person on the reader list screen as colors, character sizes, character types, and background patterns, for example, are changed.

Furthermore, in the foregoing embodiment, the case is described where the message confirmed by the responsible person is removed from the unread message list screens of the staff members other than the responsible person. However, the disclosed apparatus is not limited thereto. For example, the message confirmed by the responsible person may be removed from a received message list such as incoming trays of the staff members other than the responsible person.

In addition, in the foregoing embodiment, the case is described where the establishment is specified as a message addressee. However, the disclosed apparatus is not limited thereto. For example, for the addressee, any group may be fine as long as the group is a group to which a plurality of members belongs and a responsible person is determined.

Moreover, in the foregoing embodiment, the case is described where the message instructed to send is stored on the message control table 33 and is stored on the personal message control table 44 when a request to receive the message is first made. However, the disclosed apparatus is not limited thereto. For example, the message may be stored on the message control table 33 and the personal message control table 44 when sending is instructed.

Furthermore, the components of the devices illustrated are functionally conceptual, and are not necessarily configured physically as illustrated. Namely, the specific states of distribution and integration of the devices are not limited to ones illustrated in the drawings. All or a part of the configurations can be functionally and physically distributed and integrated in given units according to various loads and use situations, for example. For example, the processing units of the display processing unit 50, the outgoing message processing unit 51, the removing unit 52, the updating unit 53, the setting unit 54, and the adding unit 55 of the message control system 10 may be appropriately integrated. In addition, the processes of the processing units may be appropriately separated into the processes of a plurality of the processing units. Moreover, all or a given part of the process functions performed at the processing units can be implemented at a CPU and programs analyzed and run on the CPU, or can be implemented as hardware according to wired logic.

A Message Control Program

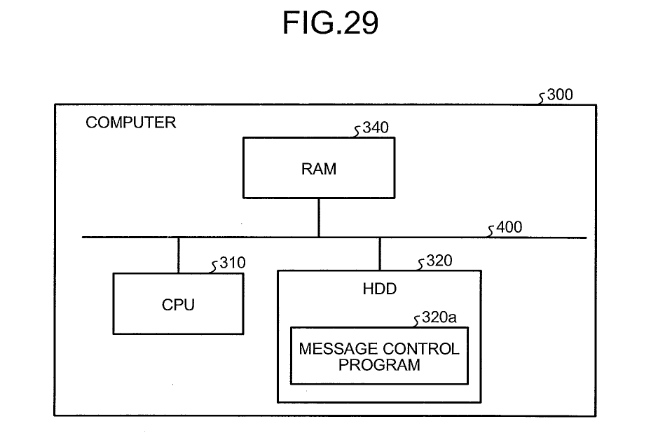

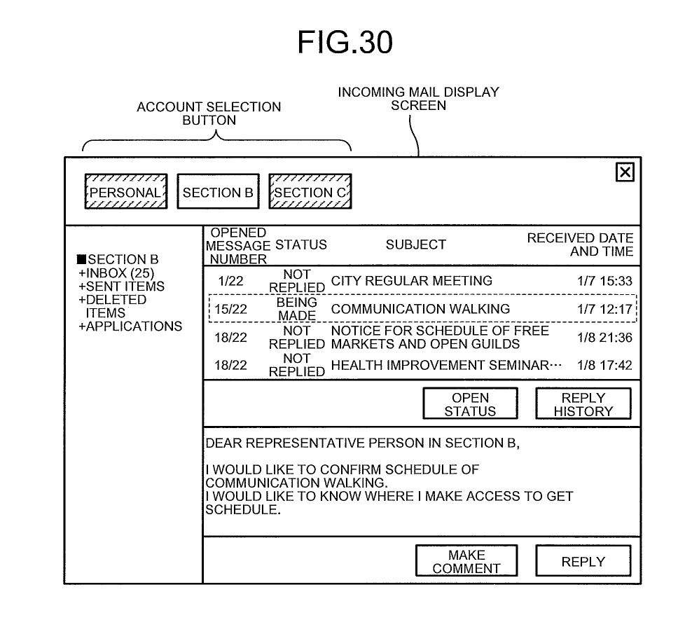

Moreover, various processes described in the foregoing embodiments may be implemented by executing a program prepared in advance on a computer system such as a personal computer and a workstation. Therefore, in the following, an exemplary computer system that executes a program including functions similar to the foregoing embodiments will be described. FIG. 29 is a diagram of a computer that executes a message control program.

As illustrated in FIG. 29, a computer 300 includes a CPU (Central Processing Unit) 310, a HDD (Hard Disk Drive) 320, and a RAM (Random Access Memory) 340. The units 300 to 340 are connected to each other through a bus 400.

The HDD 320 stores in advance a message control program 320a that exerts similar functions as the display processing unit 50, the outgoing message processing unit 51, the removing unit 52, the updating unit 53, the setting unit 54, and the adding unit 55 of the foregoing message control system 10. It is noted that the message control program 320a may be appropriately separated.

Furthermore, the HDD 320 stores various items of information. For example, the HDD 320 stores an operation system and various items of data for use in controlling messages in a selected range.

The CPU 310 then reads the message control program 320a out of the HDD 320 and executes the program 320a, and the CPU 310 executes the operations similar to the processing units of the embodiments. Namely, the message control program 320a executes the operations similar to the display processing unit 50, the outgoing message processing unit 51, the removing unit 52, the updating unit 53, the setting unit 54, and the adding unit 55.

It is noted that it is unnecessary to store the foregoing message control program 320a on the HDD 320 at the first place.

For example, it may be fine that the program is stored on a “portable physical medium” such as a flexible disk (FD), CD-ROM, DVD disk, magneto-optical disk, and IC card inserted into the computer 300 and the computer 300 then reads the program out of the medium and executes the program.

Furthermore, it may be fine that the program is stored on a “different computer (or a server)”, for example, connected to the computer 300 via a public network, the Internet, a LAN, and a WAN, for example, and the computer 300 then reads the program out of the network.

According to an aspect of the present invention, it is possible to suppress that messages unnecessary to make a confirmation are left.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A message control method comprising:
setting, based on information extracted from a message created and addressed to a group, a responsible person of the message from a plurality of members associated with the group;
adding the message to message lists of the plurality of members; and
according to confirmation of the message by the responsible person, removing the message from the message lists of the plurality of members except the responsible person.

2. The message control method according to claim 1, further comprising:
updating a confirmation notification status of the message at a sender of the message according to confirmation of the message by the responsible person.

3. The message control method according to claim 1, wherein:
the adding includes registering, a message created and addressed to the group on a shared message control table; and storing when any one of the plurality of members first makes a request to receive message, the message on the message control table is registered on a message control table for the individual members.

4. The message control method according to claim 1, further comprising:
based on responsible information on which a member to be a responsible person is stored, displaying the message on the message list of the member to be the responsible person in the plurality of members.

5. A message control method comprising:
displaying a message of a certain case created by a first responsible person who is a member of a first group, the message being addressed to a second group different from the first group in association with a second responsible person of the second group associated with the certain case.

6. The message control method according to claim 5, wherein:
the displaying includes displaying varied forms on a sent message list between when the message is confirmed by the second responsible person and when the message is confirmed by a member of the second group and different from the second responsible person.

7. A message control system comprising:
a setting unit that sets, based on information extracted from a message of a certain case created by a first responsible person who is a member of a first group, the message being addressed to a second group different from the first group, a second responsible person responsible for the message of the second group from a plurality of members corresponding to the second group;
an adding unit that adds the message to message lists of the plurality of members;
a removing unit that removes the message from the message lists of the plurality of members except the responsible person according to confirmation of the message by the responsible person; and
a display processing unit that displays the message on a message list of the first responsible person in association with the second responsible person.
